(19) United States
(12) Patent Application Publication
(10) Pub. No.: US 2016/0348584 A1
(43) Pub. Date: Dec. 1, 2016

(54) TURBOMACHINE LOAD COUPLING DEVICE HAVING A NATURAL CONVECTION VENTILATION SYSTEM

(71) Applicant: General Electric Company, Schenectady, NY (US)

(72) Inventors: Valery Ivanovich Ponyavin, Greenville, SC (US); Christopher Conrad Frese, Greer, SC (US); Carl Ricardo Lamar, Greenville, SC (US)

(21) Appl. No.: 14/721,355

(22) Filed: May 26, 2015

(51) Int. Cl. F02C 7/18; F24F 7/04; F01D 15/00; F02C 3/04; F02C 7/36

(52) U.S. Cl. CPC F02C 7/18; F02C 3/04; F02C 7/36; F01D 15/00; F24F 7/04; F05D 2220/32; F05D 2240/35; F24F 2007/004

(57) ABSTRACT

A load coupling device includes a housing including an interior portion, an ambient air inlet provided in the housing, and a load coupling guard arranged in the housing. The load coupling guard includes a turbomachine end and a load end and a passage extending therebetween. A vent extends upwardly from the load coupling guard. The vent is fluidically exposed to the load end. An ambient air inlet passage is formed in the load coupling guard and fluidically connects the ambient air inlet and the vent. The load end is substantially fluidically isolated from the turbomachine end.

### BACKGROUND OF THE INVENTION

The subject matter disclosed herein relates to the art of turbomachines and, more particularly to a turbomachine load coupling device having a natural convection ventilation system.

Gas turbomachines typically include a compressor portion, a turbine portion and a combustor assembly. The combustor assembly mixes fluid from the compressor portion with a fuel to form a combustible mixture. The combustible mixture is combusted forming hot gases that pass along a hot gas path of the turbine portion. The turbine portion includes a number of stages having airfoils mounted to rotors that convert thermal energy from the hot gases into mechanical, rotational energy. Additional fluid from the compressor is passed through the airfoils and other sections of the turbine portion for cooling purposes. Oftentimes, the turbomachine may be coupled to a load, such as a generator, through a load coupling device.

### BRIEF DESCRIPTION OF THE INVENTION

According to one aspect of an exemplary embodiment, a load coupling device includes a housing including an interior portion, an ambient air inlet provided in the housing, a load coupling shaft, and a load coupling guard arranged in the housing. The load coupling guard includes a turbomachine end and a load end and a passage extending therebetween. A vent extends upwardly from the load coupling guard. The vent is fluidically exposed to the load end. An ambient air inlet passage is formed in the load coupling guard and fluidically connects the ambient air inlet and the vent. The load end is substantially fluidically isolated from the turbomachine end.

According to another aspect of an exemplary embodiment, a turbomachine includes a compressor portion, a turbine portion operatively connected to the compressor portion, a combustor assembly fluidically connected to each of the compressor portion and the turbine portion, a load mechanically linked to one of the compressor portion and the turbine portion, and a load coupling device interfacing with the one of the compressor portion and the turbine portion and the load. The load coupling device includes a housing including an interior portion, an ambient air inlet provided in the housing, and a load coupling guard arranged in the housing. The load coupling guard includes a turbomachine end coupled to the one of the compressor portion and the turbine portion, a load end coupled to the load, and a passage extending therebetween. A vent extends upwardly from the load coupling guard. The vent is fluidically exposed to the load end. An ambient air inlet passage is formed in the load coupling guard and fluidically connects to the ambient air inlet and the vent. The load end is substantially fluidically isolated from the turbomachine end.

According to yet another aspect of an exemplary embodiment, a turbomachine includes a compressor portion, a turbine portion operatively connected to the compressor portion, a combustor assembly fluidically connected to each of the compressor portion and the turbine portion, a load mechanically linked to one of the compressor portion and the turbine portion, an intake system fluidically connected to the compressor portion, and a load coupling device interfacing with the one of the compressor portion and the turbine portion and the load. The load coupling device includes a housing including an interior portion, an ambient air inlet provided in the housing, and a load coupling guard arranged in the housing. The load coupling guard includes a turbomachine end coupled to the one of the compressor portion and the turbine portion, a load end coupled to the load, and a passage extending therebetween. A vent extends upwardly from the load coupling guard. The vent is fluidically exposed to the load end. An ambient air inlet passage is formed in the load coupling guard and fluidically connects to the ambient air inlet and the vent. The load end is substantially fluidically isolated from the turbomachine end.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic representation of a turbomachine system including a load coupling device, in accordance with an exemplary embodiment;

FIG. 2 depicts the load coupling device, in accordance with an exemplary embodiment;

FIG. 3 depicts a load coupling guard of the load coupling device, in accordance with an exemplary embodiment; and

FIG. 4 depicts a partial cross-sectional side view of the load coupling guard, in accordance with an exemplary embodiment.

The detailed description explains embodiments of the invention, together with advantages and features, by way of example with reference to the drawings.

### DETAILED DESCRIPTION OF THE INVENTION

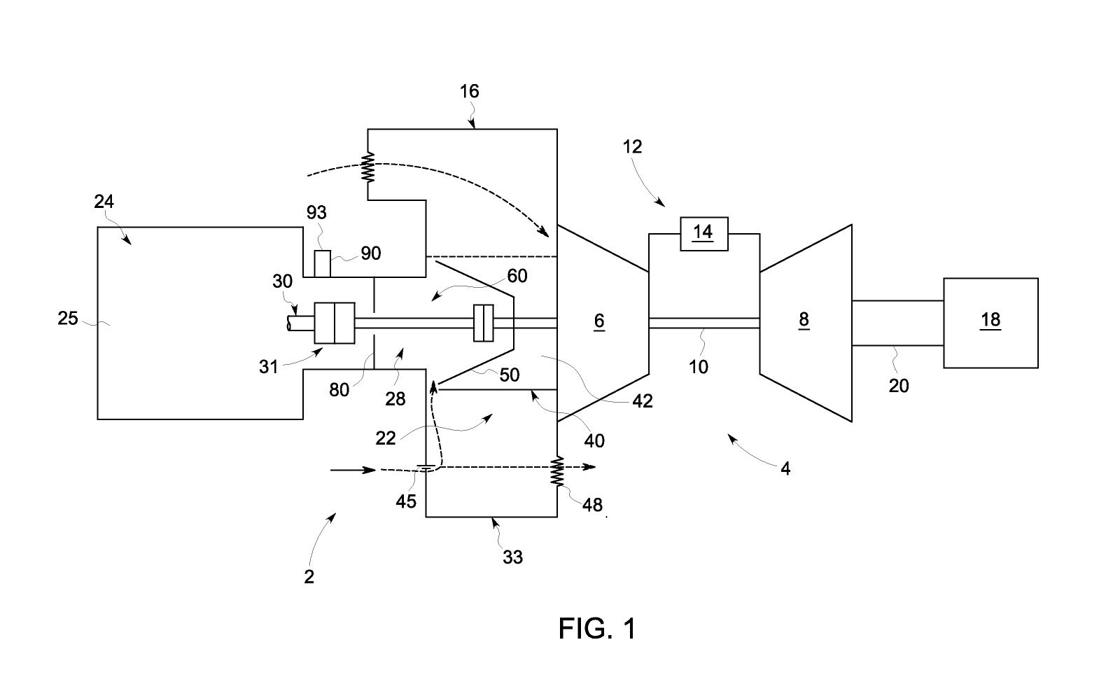

A turbomachine system, in accordance with an exemplary embodiment, is indicated generally at 2, in FIG. 1. Turbomachine system 2 includes a turbomachine 4 having a compressor portion 6 and a turbine portion 8 operatively connected by a common compressor/turbine shaft 10. Compressor portion 6 is also fluidically connected to turbine portion 8 through a combustor assembly 12. Combustor assembly 12 includes at least one combustor 14. Turbomachine system 2 also includes an intake system 16 fluidically coupled to an intake (not separately labeled) of compressor portion 6. Intake system 16 may condition an airflow passing into compressor portion 6.

An exhaust system 18 is fluidically connected to an outlet (also not separately labeled) of turbine portion 8 through a diffuser portion 20. Exhaust system 18 may condition exhaust gases passing from turbine portion 8. A load coupling device 22 provides an interface between turbomachine 4 and a load 24. Load 24 may take the form of a generator 25 coupled to compressor portion 6 through a load coupling shaft 28. Load coupling shaft 28 provides an interface between common compressor/turbine shaft 10 and a generator input/drive shaft 30. In the embodiment shown, load coupling shaft 28 is joined to generator input/drive shaft 30 through a flange 31. An airflow compartment 33 is arranged between load 24 and turbomachine 4. Airflow compartment 33 provides an airflow to load coupling device 22. As will be detailed more fully below, load coupling device 22 limits gases, such as hydrogen, produced in load 24, from passing into airflow compartment 33.

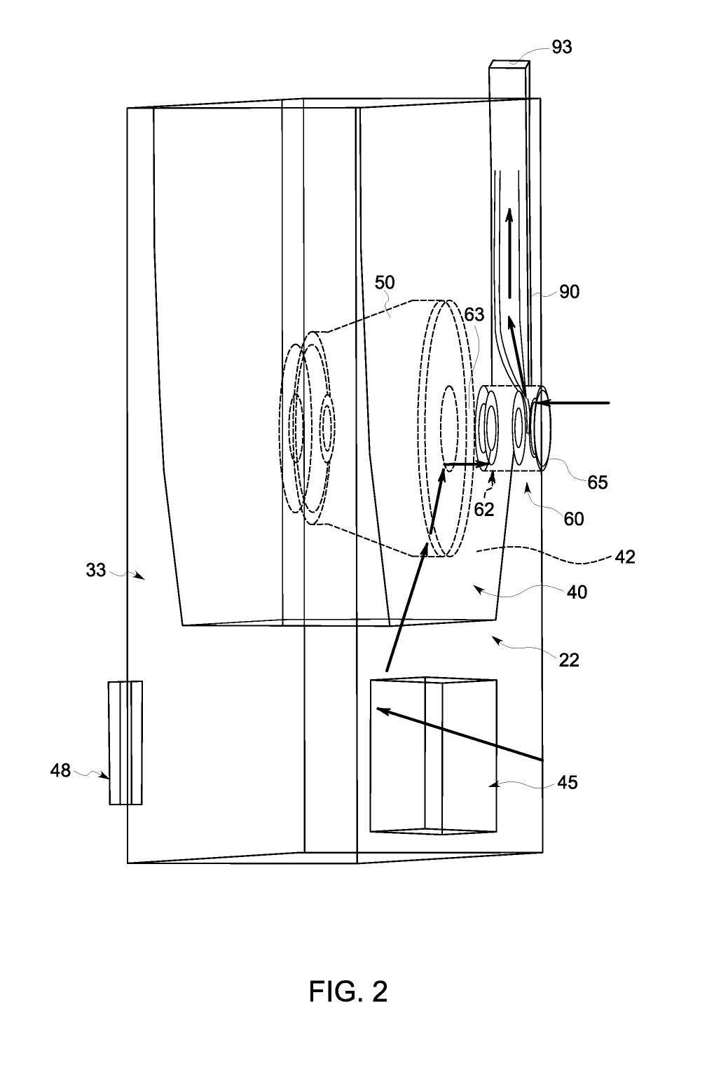

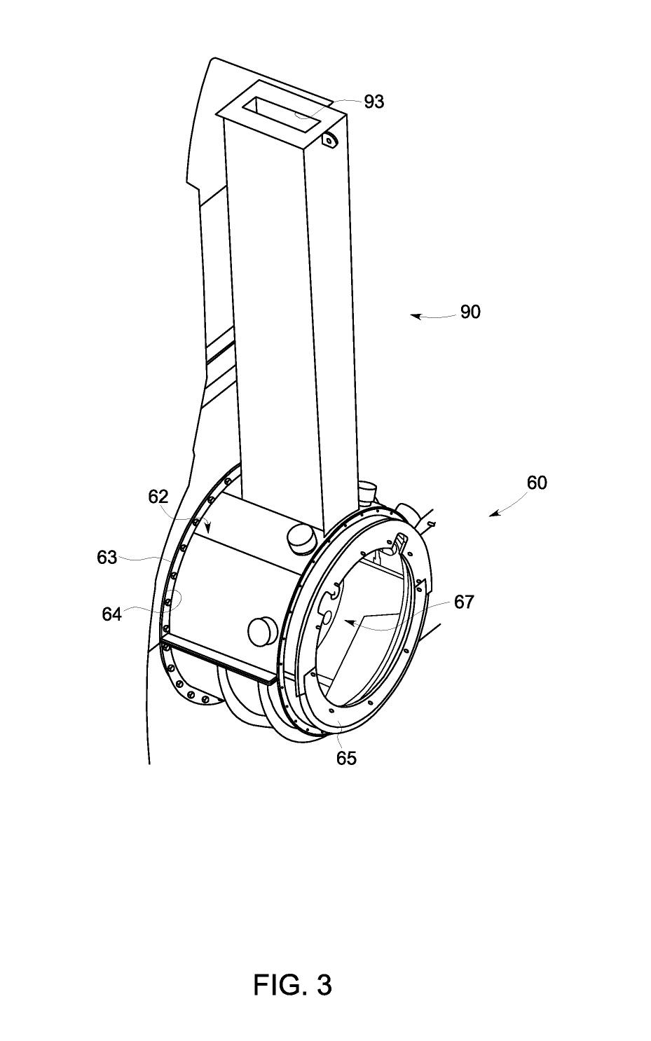

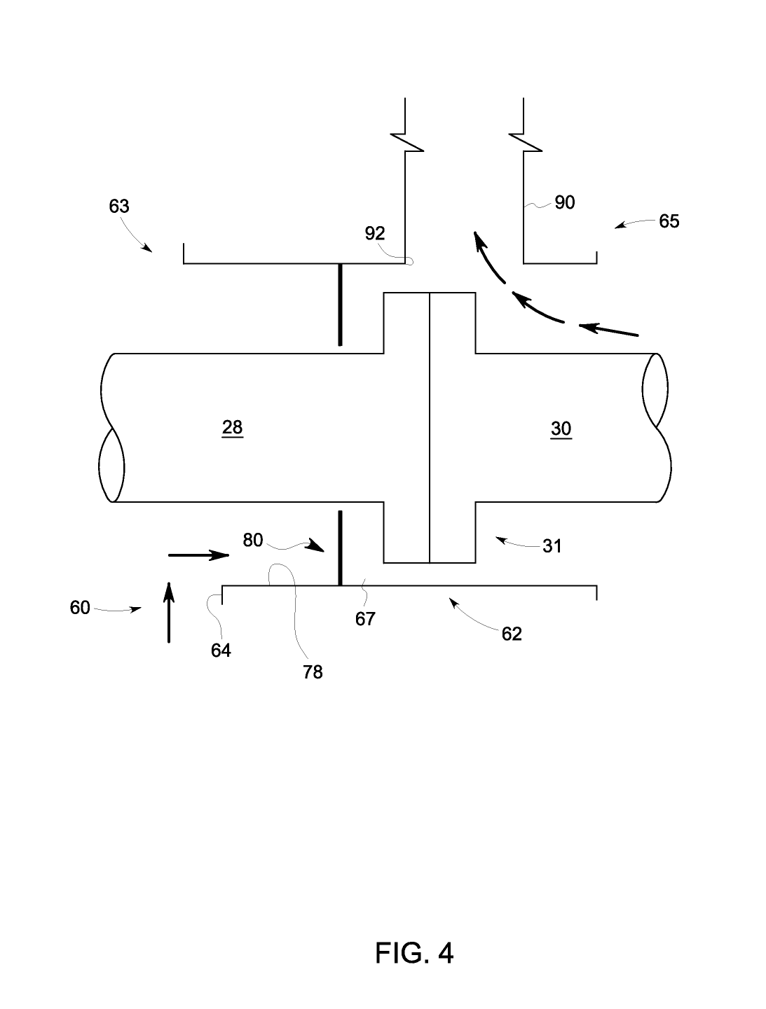

In accordance with an aspect of an exemplary embodiment illustrated in FIGS. 2-4, load coupling device 22 fluidically connected with a housing or inlet plenum enclosure 40 having an interior portion 42. Housing 40 includes an ambient air inlet 45 and an ambient air outlet 48. Ambient air outlet 48 may direct ambient air into a turbomachine compartment (not shown) housing turbomachine 4. An air-to-load coupling compartment 50 may reside within interior portion 42. In addition, load coupling device 22 houses a load coupling guard 60. In accordance with an aspect of an exemplary embodiment, load coupling guard 60 includes a body 62 having a turbomachine end 63 operatively coupled to compressor portion 6 through a flange 64 and a load end 65 operatively connected to load 24. Load coupling guard 60 may also include grounding brushes (not shown).

In still further accordance with an exemplary embodiment, load coupling guard 60 includes a passage 67 that extends between turbomachine end 63 and load end 65. Passage 67 is receptive of load coupling shaft 28 that operatively connects load 24 and turbomachine 4. Passage 67 includes an inner surface 78 from which extends a baffle member 80 that limits a flow of gases from load 24 to turbomachine 4. Baffle member 80 extends radially inwardly into passage 67 to prevent gases from flowing from load end 65 to turbomachine end 63. At this point, it should be understood that the number and location of baffle member 80 may vary.

For instance, load coupling guard 60 may include a baffle member arranged both upstream and downstream of flange 31.

In still yet further accordance with an exemplary embodiment, load coupling guard 60 includes a vent 90 that may extend upwardly from body 62. Vent 90 includes an inlet 92 fluidically connected to passage 67 and an outlet 93. Vent 90 is sized to establish a chimney effect sufficient to overcome any negative pressure in passage 67. The chimney effect draws in ambient air flowing through load coupling guard 60 and gases passing from load 24. In this manner, vent 90 cooperates with baffle member 80 to still further prevent gases passing from load 24 into turbomachine 4. In addition, the use of vent 90, coupled with ambient air, establishes a natural convective flow that reduces or eliminates the need for costly plumbing and other systems to introduce an airflow into load coupling guard 60.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A load coupling device comprising:
a housing including an interior portion;
an ambient air inlet provided in the housing;
a load coupling guard arranged in the housing, the load coupling guard including a turbomachine end and a load end and a passage extending therebetween;
a vent extending upwardly from the load coupling guard, the vent being fluidically exposed to the load end; and
an ambient air inlet passage formed in the load coupling guard and fluidically connecting the ambient air inlet and the vent, wherein the load end is substantially fluidically isolated from the turbomachine end.

2. The load coupling device according to claim 1, wherein the load coupling guard includes at least one baffle member extending into the passage, the at least one baffle member further preventing gases entering the load end from passing to the turbomachine end.

3. The load coupling device according to claim 2, wherein the at least one baffle member extends radially inwardly into the passage.

4. A turbomachine comprising:
a compressor portion;
a turbine portion operatively connected to the compressor portion;
a combustor assembly fluidically connected to each of the compressor portion and the turbine portion;
a load mechanically linked to one of the compressor portion and the turbine portion; and
a load coupling device interfacing with the one of the compressor portion and the turbine portion and the load, the load coupling device comprising:
a housing including an interior portion;
an ambient air inlet provided in the housing;
a load coupling guard arranged in the housing, the load coupling guard including a turbomachine end coupled to the one of the turbine portion and the compressor portion, a load end coupled to the load, and a passage extending therebetween;
a vent extending upwardly from the load coupling guard, the vent being fluidically exposed to the load end; and
an ambient air inlet passage formed in the load coupling guard and fluidically connecting the ambient air inlet and the vent, wherein the load end is substantially fluidically isolated from the turbomachine end.

5. The turbomachine according to claim 4, wherein the load coupling guard further includes at least one baffle member extending into the passage, the at least one baffle member further preventing gases entering the load end from passing to the turbomachine end.

6. The turbomachine according to claim 5, wherein the at least one baffle member extends radially inwardly into the passage.

7. The turbomachine according to claim 4, wherein the load is mechanically linked to the turbine portion through a shaft extending through the load coupling guard.

8. The turbomachine according to claim 4, further comprising: an air flow compartment arranged between the load and the turbomachine, wherein the load coupling device is mounted in the air flow compartment.

9. The turbomachine according to claim 4, wherein the load comprises a generator.

10. A turbomachine system comprising:
a compressor portion;
a turbine portion operatively connected to the compressor portion;
a combustor assembly fluidically connected to each of the compressor portion and the turbine portion;
an intake system fluidically connected to the compressor portion;
a load mechanically linked to one of the compressor portion and the turbine portion; and
a load coupling device interfacing with the one of the compressor portion and the turbine portion and the load, the load coupling device comprising:
a housing including an interior portion;
an ambient air inlet provided in the housing;
a load coupling guard arranged in the housing, the load coupling guard including a turbomachine end coupled to the one of the turbine portion and the compressor portion, a load end coupled to the load, and a passage extending therebetween;
a vent extending upwardly from the load coupling guard, the vent being fluidically exposed to the load end; and
an ambient air inlet passage formed in the load coupling guard and fluidically connecting the ambient air inlet and the vent, wherein the load end is substantially fluidically isolated from the turbomachine end.

11. The turbomachine system according to claim 10, wherein the load coupling guard further includes at least one baffle member extending into the passage, the at least one baffle member further preventing gases entering the load end from passing to the turbomachine end.

12. The turbomachine system according to claim 11, wherein the at least one baffle member extends radially inwardly into the passage.

13. The turbomachine system according to claim 10, wherein the load is mechanically linked to the turbine portion through a shaft extending through the load coupling guard.

14. The turbomachine system according to claim 10, further comprising:
an airflow compartment arranged between the load and the turbomachine, wherein the load coupling device is mounted in the airflow compartment.

15. The turbomachine system according to claim 10, wherein the load comprises a generator.
